(19) United States
(12) Patent Application Publication
(10) Pub. No.: US 2020/0208603 A1
(43) Pub. Date: Jul. 2, 2020

(54) Wind Power Generator

(71) Applicant: Yu-Kun Hsieh, Tainan City (TW)

(72) Inventor: Yu-Kun Hsieh, Tainan City (TW)

(21) Appl. No.: 16/237,831

(22) Filed: Jan. 2, 2019

(51) Int. Cl. F03D 1/04; H02K 11/00; H02K 7/18; F03D 9/11; H02K 7/116; H02K 11/04; F03D 9/25; F03D 15/00

(52) U.S. Cl. CPC F03D 1/04; H02K 11/0094; H02K 7/183; F03D 15/00; H02K 7/116; H02K 11/046; F03D 9/25; F03D 9/11

(57) ABSTRACT

A wind power generator includes an air exhaust unit, a generating unit, a rectifier, and a storage battery. The air exhaust unit includes a fan, a wind guide disk, and a base. The fan is provided with a bearing which is connected with a primary gear. A driven gear is connected with a transmission bearing and meshes with the primary gear. The generating unit includes a stator including a plurality of magnetic poles, and a rotor surrounding the stator and provided with a plurality of magnets. The rotor is connected with the transmission bearing. After the fan is rotated, the bearing drives the primary gear which drives the driven gear which drives the transmission bearing which drives and rotates the rotor.

### BACKGROUND OF THE INVENTION

### 1. Field of the Invention

The present invention relates to a generator and, more particularly, to a wind power generator.

### 2. Description of the Related Art

The traditional power generation methods usually employ non-renewable energy. The thermal power generation is the most widely used power generation method, which burns fossil fuels such as coal, natural gas and fuel oil, and converts the chemical energy in the fossil fuels into a heat energy by combustion, and then converts the heat energy into a mechanical energy. Finally, the mechanical energy drives the generator to produce an electrical energy. However, the gas produced after combustion forms acid rain and causes air pollution. In addition, the emitted greenhouse gases are the main cause of global warming. The nuclear power generation is another power generation method, which controls the nuclear reaction by manual labor to generate a heat energy which is converted into an electrical energy. Thus, the power generation of nuclear energy greatly reduces the greenhouse effect. However, there are problems in treatment of the radioactive nuclear waste. In addition, long-term storage of the radioactive nuclear waste may cause leakage or explosion. Further, if the nuclear fuel and the nuclear waste are not cooled in time when the cooling system fails, the stop wall will be destroyed by the high temperature and high pressure, and the radioactive material will be drained, thereby causing serious nuclear pollution. In recent years, the solar power generation has been promoted and is a popular power generation method, which uses mirrors or lenses to converge large areas of sunlight into a relatively small collection area through optical principles, so that the solar energy is concentrated. The collection area is mounted on a generator. At this time, the temperature in the light collecting area rises by irradiation of the sunlight. In such a manner, the solar energy is converted into a heat energy, and the heat energy works to drive the generator through a heat machine so as to generate electricity. However, the cost for setting up a solar power station is too high, and the solar energy is limited to the weather, so that the amount of electricity is not fixed due to the changing sunshine intensity.

### BRIEF SUMMARY OF THE INVENTION

The primary objective of the present invention is to provide a wind power generator that uses the natural resource or green energy to produce an electric power successively.

In accordance with the present invention, there is provided a wind power generator comprising an air exhaust unit, a generating unit, a rectifier, and a storage battery. The air exhaust unit includes a fan, a wind guide disk, and a base. The fan is provided with a bearing which extends downward. A primary gear is connected with the bearing and located under the fan. The base has a bottom provided with a support frame, a driven gear, and a transmission bearing. The support frame is located under and secured to the base of the air exhaust unit by screwing. The transmission bearing is located under the base and mounted on the support frame. The driven gear is located under the base and connected with the transmission bearing. The driven gear meshes with the primary gear, such that the driven gear is driven by the primary gear. The generating unit includes a stator and a rotor. The stator includes a plurality of magnetic poles. The stator is secured to the support frame by screwing. An electric line is connected with and extends from the stator. The electric line is connected with the rectifier, and is connected with the storage battery. The rotor covers and surrounds the stator and has an interior provided with a plurality of magnets. The rotor of the generating unit is connected with the transmission bearing of the base of the air exhaust unit. The transmission bearing extends through the stator and is connected with the rotor. After the fan is rotated, the bearing drives the primary gear which drives the driven gear which drives the transmission bearing which drives and rotates the rotor.

The wind power generator is mounted on a roof. When the air flows upward and passes through the wind guide disk, the fan is rotated. After the fan is rotated, the bearing drives the primary gear which drives the driven gear which drives the transmission bearing which drives the rotor, such that the rotor is rotated. When the rotor is rotated relative to the stator, the magnets of the rotor are moved successively to align with the magnetic poles of the stator reciprocally, so as to produce a magnetic field which is converted into an electric current which is rectified by the rectifier and then flows into the storage battery.

According to the primary advantage of the present invention, the fan is rotated when the air flow is convected, such that the generating unit generates an electric power simultaneously.

According to another advantage of the present invention, the air flow forms a wind energy which is converted by a magnetic effect into an electric energy whose current is rectified by the rectifier and flows into the storage battery, such that the wind power generator employs the natural source (or green energy) to produce an electric power, without causing any ecological pollution, thereby achieving an environmental protection purpose.

According to a further advantage of the present invention, the wind power generator is operated day and night without being affected by the weather, so as to provide and store the electric power successively.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is an exploded perspective view of a wind power generator in accordance with the preferred embodiment of the present invention.

FIG. 2 is a perspective view of the wind power generator in accordance with the preferred embodiment of the present invention.

FIG. 3 is another perspective view of the wind power generator in accordance with the preferred embodiment of the present invention.

FIG. 4 is a schematic operational view of the wind power generator in accordance with the preferred embodiment of the present invention.

FIG. 5 is another schematic operational view of the wind power generator in accordance with the preferred embodiment of the present invention.

FIG. 6 is another schematic operational view of the wind power generator in accordance with the preferred embodiment of the present invention.

FIG. 7 is a schematic operational view of the wind power generator in accordance with another preferred embodiment of the present invention.

FIG. 8 is a schematic operational view of the wind power generator in accordance with another preferred embodiment of the present invention.

### DETAILED DESCRIPTION OF THE INVENTION

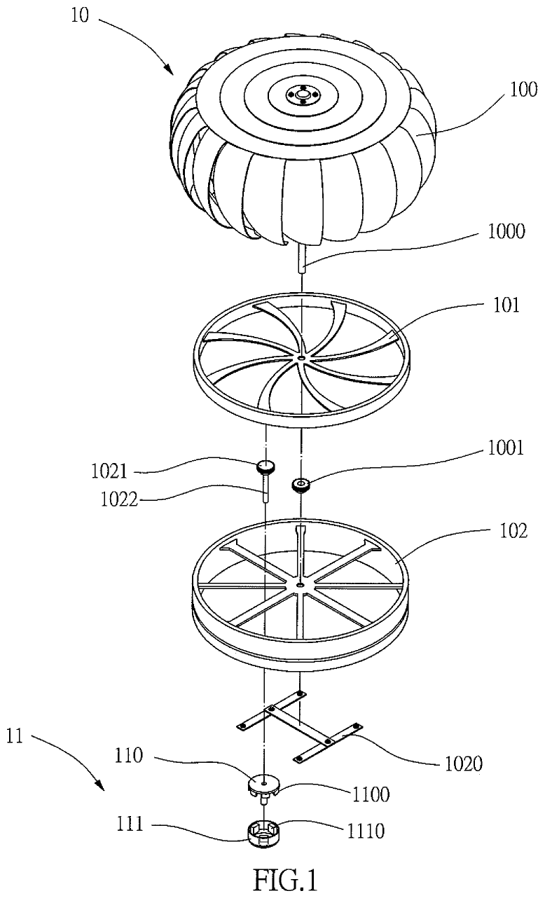

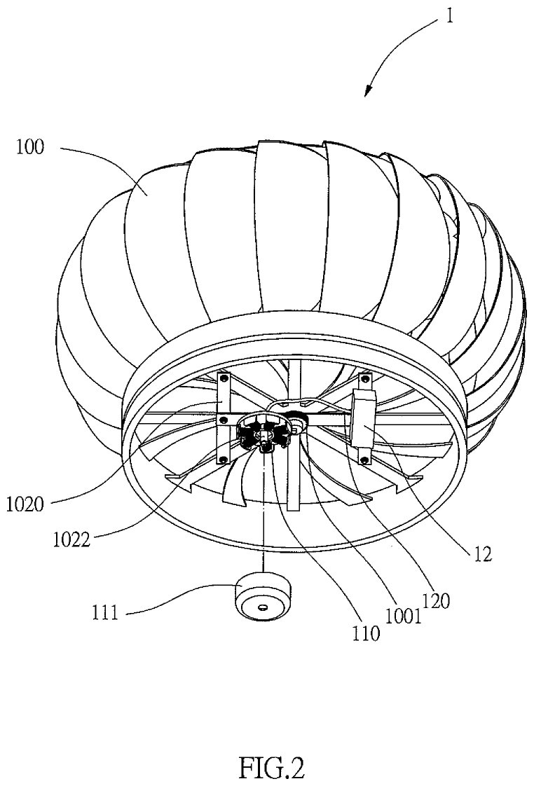

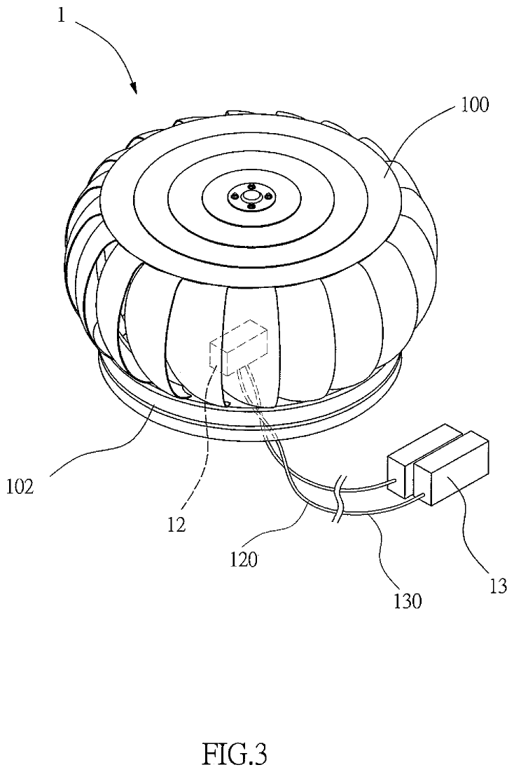

Referring to the drawings and initially to FIGS. 1-3, a wind power generator 1 in accordance with the preferred embodiment of the present. invention comprises an air exhaust (or air drain) unit (or module) 10, a generating unit (or module) 11, a rectifier 12, and a storage battery (or storage cell or accumulator) 13.

The air exhaust unit 10 includes a fan 100, a wind guide disk 101, and a base 102. The fan 100 is provided with a bearing 1000 which extends downward. Preferably, the fan 100 is a roof fan, an attic fan, a vent fan, a roof turbine, an attic ventilator, an impeller or the like. A primary gear 1001 is connected with the bearing 1000 and located under the fan 100. The bearing 1000 extends through the primary gear 1001. The base 102 has a bottom provided with a support frame (or rack) 1020, a driven gear 1021, and a transmission bearing 1022. The support frame 1020 is located under and secured to the base 102 of the air exhaust unit 10 by screwing. The transmission bearing 1022 is located under the base 102 and mounted on the support frame 1020. The driven gear 1021 is located under the base 102 and connected with the transmission bearing 1022. The driven gear 1021 meshes with the primary gear 1001, such that the driven gear 1021 is driven by the primary gear 1001. The wind guide disk 101 is located between the fan 100 and the base 102.

The generating unit 11 includes a stator 110 and a rotor 111. The stator 110 includes a plurality of magnetic poles 1100. Preferably, the stator 110 is a magnetic ring (or coil or loop or circle or disk). The stator 110 is secured to the support frame 1020 by screwing. An electric line 120 is connected with and extends from the stator 110. The electric line 120 is connected between the rectifier 12 and the stator 110. The electric line 120 is connected with the rectifier 12, and then is connected with the storage battery 13. The electric line 120 passes the rectifier 12, and an electric line 130 extends from the electric line 120 and then is connected with the storage battery 13. The rectifier 12 is secured to the support frame 1020 by screwing. The rotor 111 covers and surrounds the stator 110 and has an interior provided with a plurality of magnets (or magnetic blocks) 1110. Preferably, the rotor 111 is a swivel (or rotary) disk (or annular enclosure). The rotor 111 of the generating unit 11 is connected with the transmission bearing 1022 of the base 102 of the air exhaust unit 10. The transmission bearing 1022 extends through the stator 110 and is connected with the rotor 111, such that the rotor 111 is driven by the transmission bearing 1022 and the driven gear 1021.

In practice, when the air flows upward and passes through the wind guide disk 101, the fan 100 is rotated. After the fan 100 is rotated, the bearing 1000 drives the primary gear 1001 which drives the driven gear 1021 which drives the transmission bearing 1022 which drives the rotor 111, such that the rotor 111 is rotated. When the rotor 111 is rotated relative to the stator 110, the magnets 1110 of the rotor 111 are moved successively to align with the magnetic poles 1100 of the stator 110 reciprocally, so as to produce a magnetic field (or force) which is converted into an electric current which is rectified by the rectifier 12 and then flows into the storage battery 13.

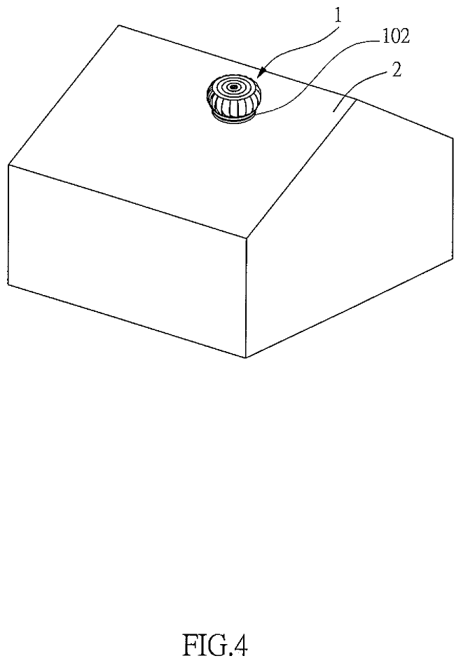

Referring to FIG. 4 with reference to FIGS. 1-3, the wind power generator 1 is mounted on a roof 2. The roof 2 is provided with a hole for mounting the base 102 of the wind power generator 1. Thus, when the hot air flows upward and passes through the wind guide disk 101, the fan 100 is rotated.

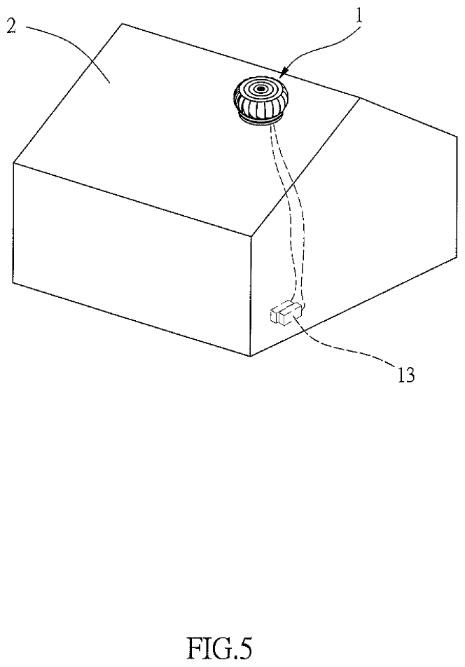

Referring to FIG. 5 with reference to FIGS. 1-4, after the fan 100 is rotated, the bearing 1000 drives and rotates the primary gear 1001 which drives and rotates the driven gear 1021 which drives the transmission bearing 1022 which drives and rotates the rotor 111, such that the rotor 111 is rotated successively. When the rotor 111 is rotated relative to the stator 110, the magnets 1110 of the rotor 111 are moved successively to pass the magnetic poles 1100 of the stator 110 reciprocally, so as to produce a magnetic field which is converted into an electric current which is rectified by the rectifier 12 and then flows into the storage battery 13 which is used to provide an electric power.

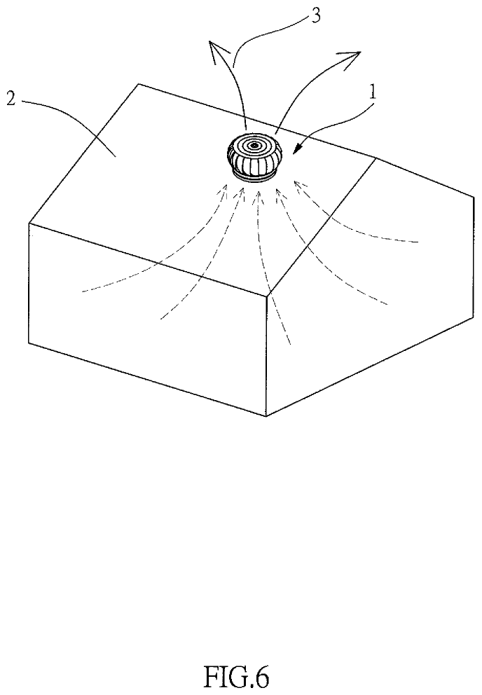

Referring to FIG. 6 with reference to FIGS. 1-5, when the wind power generator 1 generates the electric power, hot air 3 is also drained outward from the wind power generator 1 simultaneously, to achieve a ventilating and heat radiating effect.

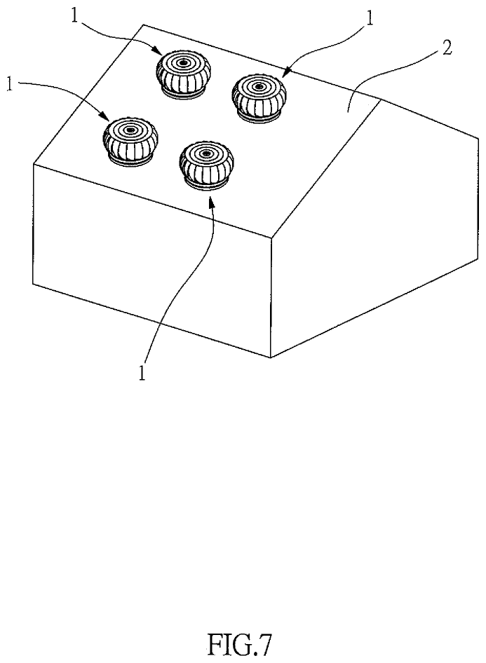

Referring to FIG. 7 with reference to FIGS. 1-3, multiple wind power generators 1 are mounted on the roof 2. The roof 2 is provided with multiple holes for mounting the base 102 of each of the wind power generators 1. In such a manner, when the hot air flows upward and passes through the wind guide disk 101 of each of the wind power generators 1, the fan 100 of each of the wind power generators 1 is rotated. Thus, each of the wind power generators 1 is operated to produce electricity individually. It is appreciated that, the wind power generators 1 are connected in parallel, to provide an electric power.

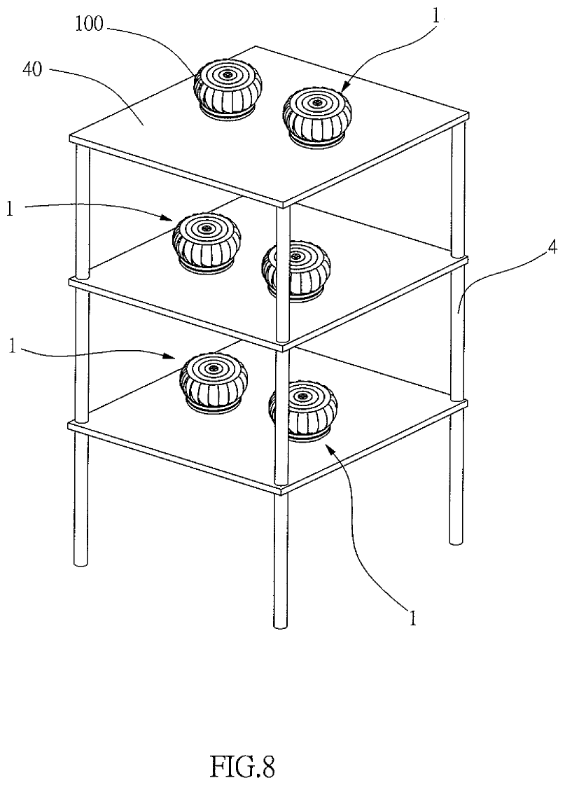

Referring to FIG. 8 with reference to FIGS. 1-3, multiple wind power generators 1 are mounted on a shelf 4. The shelf 4 includes a plurality of sheet layers 40 for placing and mounting the wind power generators 1. The sheet layers 40 of the shelf 4 are provided with multiple holes for mounting the wind power generators 1. In such a manner, when the hot air flows upward and passes through the wind guide disk 101 of each of the wind power generators 1, the fan 100 of each of the wind power generators 1 is rotated. Thus, each of the wind power generators 1 is operated to produce electricity individually. It is appreciated that, the wind power generators 1 are connected in parallel, to provide an electric power. Thus, the shelf 4 provides a large number of wind power generators 1 so as to supply a large amount of electricity.

Accordingly, the fan 100 is rotated when the air flow is convected, such that the generating unit 11 generates an electric power simultaneously. In addition, the air flow forms a wind energy which is converted by a magnetic effect into an electric energy whose current is rectified by the rectifier 12 and flows into the storage battery 13, such that the wind power generator 1 employs the natural source (or green energy) to produce an electric power, without causing any ecological pollution, thereby achieving an environmental protection purpose. Further, the wind power generator 1 is operated day and night without being affected by the weather, so as to provide and store the electric power successively.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A wind power generator comprising:
an air exhaust unit, a generating unit, a rectifier, and a storage battery;
wherein:
the air exhaust unit includes a fan, a wind guide disk, and a base;
the fan is provided with a bearing which extends downward;
a primary gear is connected with the bearing and located under the fan;
the base has a bottom provided with a support frame, a driven gear, and a transmission bearing;
the support frame is located under and secured to the base of the air exhaust unit by screwing;
the transmission bearing is located under the base and mounted on the support frame;
the driven gear is located under the base and connected with the transmission bearing;
the driven gear meshes with the primary gear, such that the driven gear is driven by the primary gear;
the generating unit includes a stator and a rotor;
the stator includes a plurality of magnetic poles;
the stator is secured to the support frame by screwing;
an electric line is connected with and extends from the stator;
the electric line is connected with the rectifier, and is connected with the storage battery;
the rotor covers and surrounds the stator and has an interior provided with a plurality of magnets;
the rotor of the generating unit is connected with the transmission bearing of the base of the air exhaust unit; and
the transmission bearing extends through the stator and is connected with the rotor.

2. The wind power generator of claim 1, wherein after the fan is rotated, the bearing drives the primary gear which drives the driven gear which drives the transmission bearing which drives and rotates the rotor.
